(19) United States
(12) Patent Application Publication
(10) Pub. No.: US 2012/0161701 A1
(43) Pub. Date: Jun. 28, 2012

(54) POWER CONTROL SYSTEM

(75) Inventors: Shinya KAWAMOTO, Yokohama-shi (JP); Yasuhiro OGURA, Yokohama-shi (JP); Tamotsu ENDO, Tokyo (JP)

(73) Assignee: KABUSHIKI KAISHA TOSHIBA, Tokyo (JP)

(21) Appl. No.: 13/237,156

(22) Filed: Sep. 20, 2011

(30) Foreign Application Priority Data
Dec. 28, 2010 (JP) JP2010-292249

(51) Int. Cl. H02J 7/04

(52) U.S. Cl. 320/109

(57) ABSTRACT

A power control system includes a house power controller and a vehicle power controller connected by a power cable. The house power controller includes a control signal generator; a switch that operates responsive to a control signal instructing a charged amount, and passes/stops AC power coming from a power distribution system; a selector switch that switches whether to send AC power to the power cable, or to output DC power from the power cable; and a power converter converting DC power from the selector switch into AC power, and sending AC power to the power distribution system. The vehicle power controller includes a battery storing DC power; a vehicle-side selector switch that switches whether to send DC power from the battery to the power cable, or to output AC power from the power cable; and a charger that charges the battery with AC power from the vehicle-side selector switch.

### CROSS-REFERENCE TO RELATED APPLICATION

This application is based upon and claims the benefit of priority from Japanese Patent Application No. 2010-292249, filed Dec. 28, 2010; the entire contents of which are incorporated herein by reference.

### FIELD

Embodiments described herein relate generally to a power control system that manages power at home.

### BACKGROUND

In-home use of energy of a storage battery mounted on an electric vehicle (hereinafter, referred to as a “vehicle-mounted battery”) is referred to as V2H (Vehicle to Home), and the vehicle-mounted battery with a large capacity is used as power storage facility when the electric vehicle is not used as transportation. This is referred to as use in in-home interconnection. As a representative of in-home energy saving technologies, HEMS (Home Energy Management System) is known. This is a system that connects in-home electrical appliances and hot-water-supply instruments to one another through a network and automatically controls the in-home electrical appliances and hot-water-supply instruments. This system visualizes a usage situation of the energy, thus making it possible to urge a user to save energy, and moreover, making it possible to restrict an amount of the energy used by such instruments. Technical development for using the electric vehicle as the in-home power storage facility by combining the HEMS and the V2H with each other is ongoing at present.

Moreover, performing power interchange between the electric vehicle and a power system by interconnecting the electric vehicle to the power system is referred to as V2G (Vehicle to Grid), and also here, the vehicle-mounted battery with a large capacity is used as the power storage facility when the electric vehicle is not used as transportation. This is referred to as use in system interconnection. A smart grid is known as one of effective means for interconnecting, to the power system, renewable energy such as wind power generation, photovoltaic power generation (photovoltaics; PV), and the like, in which outputs are unstable. This is a technology for unifying the existing power system with the storage battery, a dispersed power supply and the like by using information communication technologies, thereby enabling the power interchange bidirectionally.

The current electric vehicle is capable of only charge from the power system (power distribution system) to the vehicle-mounted battery, and is incapable of discharge in a reverse direction, that is, from the vehicle-mounted battery to the power distribution system. In order to perform the discharge from the vehicle-mounted battery to the power distribution system, it is necessary to install, on a vehicle side or a house side, a power conversion system (PCS) for converting DC power of the vehicle-mounted battery into AC power of the power distribution system. Moreover, a charged amount cannot be controlled in the case of performing the charge from the power distribution system to the vehicle-mounted battery. Furthermore, in the case of performing the charge from the power distribution system to the vehicle-mounted battery, it is necessary to connect the house side and the vehicle side to each other by a cable for the charge; however, the current cable cannot be used for transferring control signals.

### BRIEF DESCRIPTION OF THE DRAWINGS

FIG. 1 is a block diagram illustrating a configuration of a power control system according to a first embodiment.

FIG. 2 is a block diagram illustrating a configuration of a power control system according to a second embodiment.

FIG. 3 is a block diagram illustrating a configuration of a power control system according to a third embodiment.

FIG. 4 is a block diagram illustrating a configuration of a power control system according to a fourth embodiment.

FIG. 5 is a block diagram illustrating a configuration of a power control system according to a fifth embodiment.

### DETAILED DESCRIPTION

According to one embodiment, a power control system includes: a house power control device for controlling power on a house side; a vehicle power control device for controlling power on a vehicle side; and a power cable for transferring power between the house power control device and the vehicle power control device.

The house power control device includes: a control signal creation unit; a switch; a house-side selector switch; a power conversion system. The control signal creation unit creates a control signal. The switch opens and closes in response to the control signal instructing a charged amount, which is sent from the control signal creation unit, thereby controls passing or stopping of AC power coming from a power distribution system. In response to a control signal instructing charge/discharge, which is sent from the control signal creation unit, the house-side selector switch switches whether to send the AC power, which comes from the switch, from a house to a vehicle through the power cable, or to output DC power, which comes from the vehicle, to a power distribution system side through the power cable. In response to a control signal instructing a discharged amount, which is sent from the control signal generation unit, the power conversion system converts the DC power, which is outputted from the house-side selector switch, into AC power, and sends out the AC power to the power distribution system.

The vehicle power control device includes: a vehicle-mounted battery that stores DC power; a vehicle-side selector switch; and a charger. In response to the control signal instructing the charge/discharge, which is sent from the control signal creation unit, the vehicle-side selector switch switches whether to send DC power, which comes from the vehicle-mounted battery, to the power cable, or to output the AC power, which comes from the power cable. The charger charges the vehicle-mounted battery based on the AC power outputted from the vehicle-side selector switch.

Various embodiments will be described hereinafter with reference to the accompanying drawings.

### First Embodiment

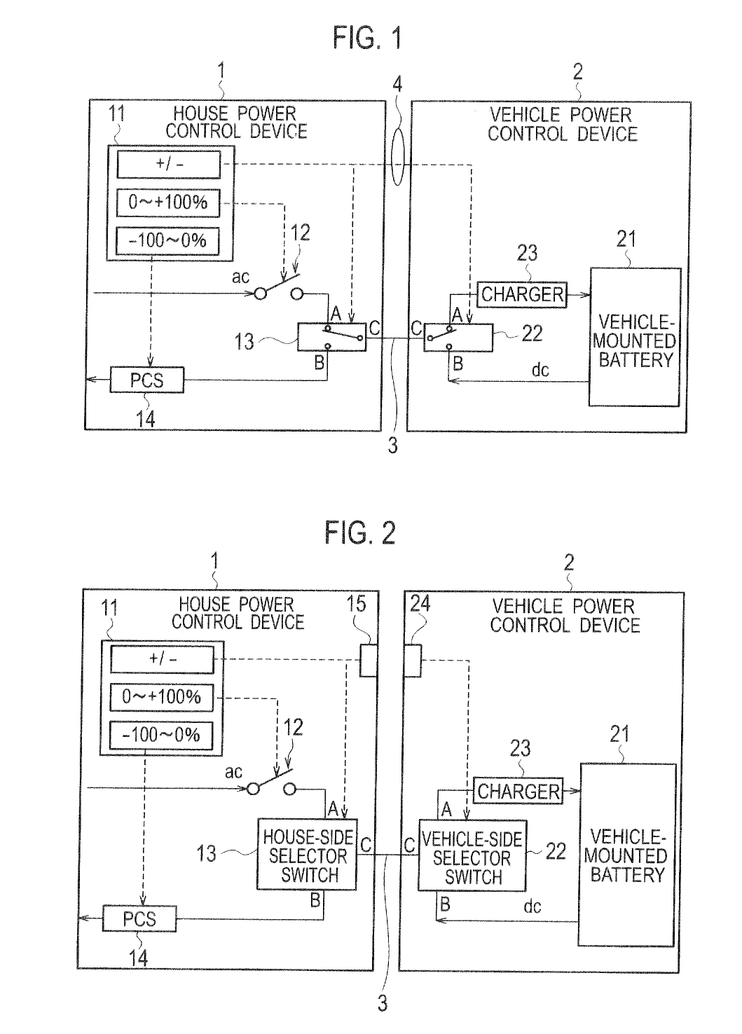

As illustrated in FIG. 1, a power control system according to a first embodiment includes: a house power control device 1 for controlling power on a house side; a vehicle power control device 2 for controlling power on a vehicle side; a power cable 3; and a communication cable 4. The power cable 3 transfers power between the house power control device 1 and the vehicle power control device 2. The communication cable 4 transfers information between the house power control device 1 and the vehicle power control device 2. The power cable 3 and the communication cable 4 are fitted to connectors provided individually on the house power control device 1 and the vehicle power control device 2. However, a rendering of the connectors is omitted in FIG. 1.

First, a description will be made of the house power control device 1. The house power control device 1 includes: a control signal creation unit 11; a switch 12; a house-side selector switch 13; and a power conversion system (PCS) 14.

The control signal creation unit 11 creates a control signal instructing that charge/discharge (charge (+) or discharge (−)) should be performed, then sends the control signal to the house-side selector switch 13, in addition, creates a control signal issuing an instruction on a charged amount (0 to 100%), then sends the control signal to the switch 12, and further, creates a control signal issuing an instruction on a discharged amount (−100 to 0%), then sends the control signal to the PCS 14. The control signal creation unit 11 can be configured so as to instruct such discharge by the control signal instructing the charge/discharge in the case where AC power for a house is insufficient.

The switch 12 is composed of an ON/OFF switch made of, for example, a semiconductor switch, an electromagnetic relay, or the like. The switch 12 opens and closes in response to the control signal instructing the charged amount, which is sent from the control signal creation unit 11, and controls passing or stopping of AC power inputted from a power distribution system. The AC power that passes through the switch 12 is sent to the house-side selector switch 13. The charged amount of 0 to 100% is instructed depending on an ON duty of the switch 12.

The house-side selector switch 13 is composed of a three-terminal switch made of, for example, an electromagnetic relay, a semiconductor switch, or the like. In response to the control signal instructing the charge/discharge, which is sent from the control signal creation unit 11, the house-side selector switch 13 switches whether to send, to the power cable 3, the AC power from the switch 12, or to send, to the PCS 14, DC power from the power cable 3. Specifically, in the case where the charge is instructed by the control signal instructing the charge/discharge, a common terminal C is connected to a terminal A, and the AC power from the switch 12 is sent to the power cable 3. Meanwhile, in the case where the discharge is instructed, the common terminal C is connected to a terminal B, and the DC power from the power cable 3 is sent to the PCS 14.

The PCS 14 converts the DC power, which is outputted from the house-side selector switch 13, into AC power, and sends out the AC power to the power distribution system by a discharged amount of −100 to 0%, which corresponds to the control signal instructing the discharged amount, the control signal being sent from the control signal creation unit 11. As the PCS 14, a PCS oriented for a home-use PV (photovoltaics) can be used.

Next, a description will be made of the vehicle power control device 2. The vehicle power control device 2 includes: a vehicle-mounted battery 21; a vehicle-side selector switch 22; and a charger 23.

The vehicle-mounted battery 21 is composed of a storage battery, and stores DC power. The DC power stored in the vehicle-mounted battery 21 is sent from the vehicle-side selector switch 22 through the house power control device 1 to the power distribution system, and is used as electric energy in home, as well as is supplied, for example, as a power source of the electric vehicle to a motor (not illustrated).

The vehicle-side selector switch 22 is composed of a three-terminal switch made of, for example, an electromagnetic relay, a semiconductor switch, or the like. In response to the control signal instructing the charge/discharge, which is sent from the control signal creation unit 11 of the house power control device 1, the vehicle-side selector switch 22 switches whether to send, to the power cable 3, the DC power from the vehicle-mounted battery 21, or to supply, to the charger 23, the AC power from the power cable 3. Specifically, in the case where the charge is instructed by the control signal instructing the charge/discharge, a common terminal C is connected to a terminal A, and the AC power from the power cable 3 is supplied to the charger 23. Meanwhile, in the case where the discharge is instructed, the common terminal C is connected to a terminal B, and the DC power from the vehicle-mounted battery 21 is sent to the power cable 3.

The charger 23 converts the AC power, which comes from the vehicle-side selector switch 22, into a DC power, and sends the DC power to the vehicle-mounted battery 21. In such a way, the vehicle-mounted battery 21 is charged.

As described above, in accordance with the first embodiment, the power cable 3 provided between the house power control device 1 and the vehicle power control device 2 is used in a switched manner between the charge time and the discharge time. Therefore, an independent power cable for returning the DC power, which comes from the vehicle power control device 2, to the house power control device 1 is unnecessary. As a result, it is unnecessary to modify an exterior of a vehicle body.

Moreover, the conversion from the DC power into the AC power is performed on the house power control device 1 on the house side. As a result, it is unnecessary to modify the exterior of the vehicle body. Moreover, the conversion from the DC power into the AC power is performed by the PCS oriented for the home-use PV, which is included in the house power control device 1 on the house side. Therefore, a system interconnection function of the PCS can be used for the conversion from the DC power into the AC power.

Furthermore, the charged amount is controlled from 0 to +100% only by controlling ON/OFF of an AC power supply. Therefore, it is unnecessary to change a main circuit of the electric vehicle.

### Second Embodiment

In a second embodiment, the transfer of the signal between the house power control device 1 and the vehicle power control device 2 in the power control system according to the first embodiment is performed by wireless communication in place of using the communication cable 4.

As illustrated in FIG. 2, a power control system according to the second embodiment is configured in such a manner that the communication cable 4 is removed from the power control system according to the first embodiment, that a house-side communication unit 15 is added to the house power control device 1, and that a vehicle-side communication unit 24 is added to the vehicle power control device 2.

The house-side communication unit 15 of the house power control device 1 transmits the control signal instructing the charge/discharge, which is sent from the control signal creation unit 11, wirelessly, for example, by a radio wave, light and the like.

The vehicle-side communication unit 24 of the vehicle power control device 2 receives the signal transmitted wirelessly from the house-side communication unit 15, and sends the received signal as the control signal, which indicates the charge/discharge, to the vehicle-side selector switch 22. In response to the control signal instructing the charge/discharge, which is sent from the control signal creation unit 11 of the house power control device 1 through the house-side communication unit 15 and the vehicle-side communication unit 24, the vehicle-side selector switch 22 switches whether to send, to the power cable 3, the DC power from the vehicle-mounted battery 21, or to send, to the charger 23, the AC power from the power cable 3.

In accordance with the power control system according to the second embodiment, the transfer of the control signal instructing the charge/discharge performed between the house side and the vehicle side is performed wirelessly, and accordingly, the communication cable becomes unnecessary, and it becomes unnecessary to modify the exterior of the vehicle body.

Note that, in the power control system, the vehicle-side selector switch 22 can be modified so as to switch whether to send, to the power cable 3, the DC power from the vehicle-mounted battery 21 or to output the AC power from the power cable 3 in response to a control signal sent by PLC (Power Line Communication), specifically, a control signal instructing the charge/discharge, which is sent from the control signal creation unit 11 of the house power control device 1 while being superimposed on the power (AC power or DC power) transferred by the power cable 3. In accordance with the power control system according to this modification example of the second embodiment, similar effects to those of the second embodiment are obtained.

### Third Embodiment

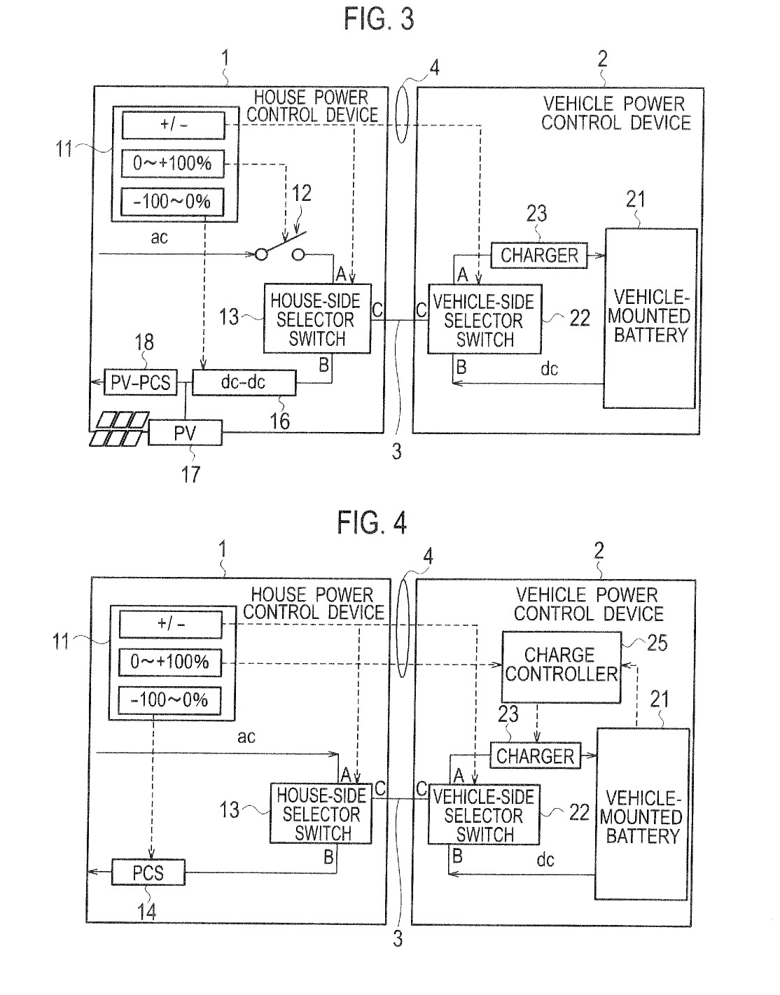

In a third embodiment, the house power control device 1 of the power control system according to the first embodiment is configured by using the function of the existing PV (photovoltaics). As illustrated in FIG. 3, a power control system according to the third embodiment is configured in such a manner that the PCS 14 is removed from the house power control device 1 according to the first embodiment, and in addition, that there are added a DC-DC converter 16, a PV (photovoltaics) device 17, and a power conversion system for photovoltaics (PV-PCS) 18.

In response to the control signal instructing the discharged amount, which is sent from the control signal generation unit 11, the DC-DC converter 16 converts a voltage of DC power, which is outputted from the house-side selector switch 13, into a voltage corresponding to a voltage by the photovoltaics, and sends the converted voltage to the PV-PCS 18. At this time, as the control signal instructing the discharged amount, a signal that varies the ON duty can be used.

The PV device 17 is connected to an output terminal of the DC-DC converter 16, and DC power generated by the photovoltaic power generation is supplied thereto. Note that there can be adopted a simple configuration made to use a diode, in which an anode is connected to the house-side selector switch 13, in place of the DC-DC converter 16.

The PV-PCS 18 converts the DC power from the DC-DC converter 16 and DC power from the PV device 17 into AC power, and sends out the converted AC power to the power distribution system.

As described above, in accordance with the power control system according to the third embodiment, control to set the discharged amount at −100% to 0% is performed by the DC-DC converter 16. Therefore, the PV-PCS can be shared also for the conversion from the DC power to the AC power. As a result, it becomes unnecessary to modify the PCS.

### Fourth Embodiment

In a fourth embodiment, the control of the charged amount in the power control system according to the first embodiment is performed in the vehicle power control device 2. As illustrated in FIG. 4, a power control system according to the fourth embodiment is configured so that the switch 12 can be removed from the house power control device 1 of the power control system according to the first embodiment, and in addition, that the control signal instructing the charged amount, which is created in the control signal creation unit 11, can be sent to the vehicle power control device 2 through the communication cable 4. The vehicle power control device 2 is configured by being added with a charge controller 25.

The charge controller 25 creates a charged amount control signal, which instructs the charged amount, based on the control signal instructing the charged amount, which is sent from the control signal creation unit 11 through the communication cable 4, and on a signal indicating a battery residual amount, which is sent from the vehicle-mounted battery 21. In such a way, the charger 23 charges the vehicle-mounted battery 21 with a charged amount corresponding to the charged amount control signal coming from the charge controller 25.

In accordance with the fourth embodiment, the charger 23 of the vehicle power control device 2 is controlled in response to the instruction from the house power control device 1, whereby control to set the charged amount at 0 to 100% is performed. Therefore, it is unnecessary to provide a switch on the house side.

### Fifth Embodiment

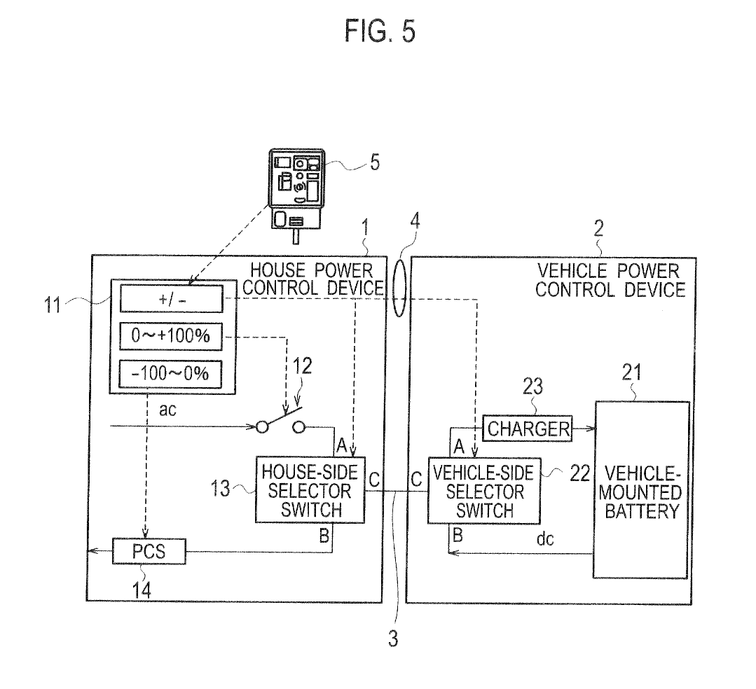

As illustrated in FIG. 5, a power control system according to a fifth embodiment is configured so that operations of the control signal creation unit 11 in the house power control device 1 of the power control system according to the first embodiment can be controlled by a smart meter 5.

The smart meter 5 is a wattmeter having a communication function for performing communication with a center (for example, an electric power company). The smart meter 5 receives an instruction through the communication from the electric power company, and sends, to the control signal creation unit 11, a command to instruct the operations thereof. This command includes an instruction to the effect that there should be created the control signal instructing the charge/discharge, the control signal instructing the charged amount, and the control signal instructing the discharged amount.

In response to the command from the smart meter 5, the control signal creation unit 11 creates the control signal instructing the charge/discharge, then sends the control signal to the house-side selector switch 13 and the vehicle power control device 2, creates the control signal instructing the charged amount, then sends the control signal to the switch 12, and/or creates the control signal instructing the discharged amount, then sends the control signal to the PCS 14.

In accordance with the power control system according to the fifth embodiment, the instruction on the charge/discharge, the instruction on the charged amount and the instruction on the discharged amount are performed by using the smart meter 5, and accordingly, operations become simple.

Note that, in the power control system according to the fifth embodiment, operations of the control signal creation unit 11 in the house power control device 1 of the power control system according to the first embodiment are controlled by the smart meter 5. In place of this, there can be adopted a configuration made to control, by the smart meter 5, operations of the control signal creation unit 11 in the house power control device 1 of the power control system according to the fourth embodiment

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power control system comprising:
a house power control device for controlling power on a house side;
a vehicle power control device for controlling power on a vehicle side; and
a power cable for transferring power between the house power control device and the vehicle power control device, wherein
the house power control device includes:
a control signal creation unit for creating a control signal;
a switch that opens and closes in response to the control signal instructing a charged amount, the control signal being sent from the control signal creation unit, thereby controls passing or stopping of AC power coming from a power distribution system;
a house-side selector switch that, in response to a control signal instructing charge/discharge, the control signal being sent from the control signal creation unit, switches whether to send the AC power, which comes from the switch, from a house to a vehicle through the power cable, or to output DC power, which comes from the vehicle, to a power distribution system side through the power cable; and
a power conversion system that, in response to a control signal instructing a discharged amount, the control signal being sent from the control signal generation unit, converts the DC power, which is outputted from the house-side selector switch, into AC power, and sends out the AC power to the power distribution system, and
the vehicle power control device includes:
a vehicle-mounted battery that stores DC power;
a vehicle-side selector switch that, in response to the control signal instructing the charge/discharge, the control signal being sent from the control signal creation unit, switches whether to send DC power, which comes from the vehicle-mounted battery, to the power cable, or to output the AC power, which comes from the power cable; and
a charger that charges the vehicle-mounted battery based on the AC power outputted from the vehicle-side selector switch.

2. The power control system according to claim 1, further comprising:
a communication cable that transfers information between the house power control device and the vehicle power control device, wherein
in response to the control signal instructing the charge/discharge, the control signal being sent from the control signal creation unit through the communication cable, the vehicle-side selector switch switches whether to send the DC power, which comes from the vehicle-mounted battery, to the power cable, or to output the AC power, which comes from the power cable.

3. The power control system according to claim 1, wherein
the house power control device further includes a house-side communication unit that wirelessly transmits the control signal instructing the charge/discharge, the control signal being sent from the control signal creation unit,
the vehicle power control device further includes a vehicle-side communication unit that wirelessly receives the control signal instructing the charge/discharge, the control signal being wirelessly sent from the house-side communication unit, and
in response to the control signal instructing the charge/discharge, the control signal being sent from the control signal creation unit through the house-side communication unit and the vehicle-side communication unit, the vehicle-side selector switch switches whether to send the DC power, which comes from the vehicle-mounted battery, to the power cable, or to output the AC power, which comes from the power cable.

4. The power control system according to claim 1, wherein
in response to a control signal instructing the charge/discharge, the control signal being sent from the control signal creation unit while being superimposed on the AC power or DC power transferred by the power cable, the vehicle-side selector switch switches whether to send the DC power, which comes from the vehicle-mounted battery, to the power cable, or to output the AC power, which comes from the power cable.

5. The power control system according to claim 1, wherein
the house power control device further includes a DC-DC converter that, in response to the control signal instructing the charge/discharge, the control signal being sent from the control signal creation unit, converts a voltage of the DC power, which is outputted from the house-side selector switch, into a voltage corresponding to voltage by photovoltaics, and
the power conversion system converts the DC power, which is outputted from the DC-DC converter, into AC power, and sends out the AC power to the power distribution system.

6. The power control system according to claim 1, further comprising:
a smart meter that outputs a command corresponding to an instruction received by communication, wherein
the control signal creation unit creates the control signal in response to the command coming from the smart meter.

7. A power control system comprising:
a house power control device for controlling power on a house side;
a vehicle power control device for controlling power on a vehicle side; and
a power cable for transferring power between the house power control device and the vehicle power control device, wherein
the house power control device includes:
a control signal creation unit for creating a control signal;
a house-side selector switch that, in response to a control signal instructing charge/discharge, the control signal being sent from the control signal creation unit, switches whether to send AC power, which comes from a power distribution system, to the power cable, or to output DC power, which comes from the power cable; and
a power conversion system that, in response to a control signal instructing a discharged amount, the control signal being sent from the control signal generation unit, converts the DC power, which is outputted from the house-side selector switch, into AC power, and sends out the AC power to the power distribution system, and
the vehicle power control device includes:
a vehicle-mounted battery that stores DC power;
a vehicle-side selector switch that, in response to the control signal instructing the charge/discharge, the control signal being sent from the control signal creation unit, switches whether to send DC power, which comes from the vehicle-mounted battery, to the power cable, or to output the AC power, which comes from the power cable;
a charge controller that creates a charged amount control signal, which instructs a charged amount, in response to the control signal instructing a charged amount, the control signal being sent from the control signal creation unit, and to a signal indicating a battery residual amount, the signal being sent from the vehicle-mounted battery; and
a charger that charges the vehicle-mounted battery with a charged amount corresponding to the charged amount control signal coming from the charge controller based on the AC power outputted from the vehicle-side selector switch.

8. The power control system according to claim 7, further comprising:
a smart meter that outputs a command corresponding to an instruction received by communication, wherein
the control signal creation unit creates the control signal in response to the command coming from the smart meter.
